(19) United States
(12) Patent Application Publication
(10) Pub. No.: US 2020/0077677 A1
(43) Pub. Date: Mar. 12, 2020

(54) PECKING BLOCK AND METHOD OF PREPARATION THEREOF

(71) Applicant: ABSORBENT PRODUCTS LTD., Kamloops (CA)

(72) Inventors: Peter B. Aylen, Kamloops (CA); Steven W. Gurney, Kamloops (CA); Jennifer Bylycia, Kamloops (CA); Richard Barry Baker, Kamloops (CA); Reed Schneider, Hortonville, WI (US)

(73) Assignee: ABSORBENT PRODUCTS LTD., Kamloops (CA)

(21) Appl. No.: 16/565,208

(22) Filed: Sep. 9, 2019

Related U.S. Application Data
(60) Provisional application No. 62/728,675, filed on Sep. 7, 2018.

(30) Foreign Application Priority Data
Sep. 7, 2018 (CA) 3016928

(51) Int. Cl. A23K 20/28; A01K 39/01; A23K 20/24; A23K 40/20; A23K 50/75

(52) U.S. Cl. CPC A23K 20/28; A01K 39/0106; A23K 50/75; A23K 40/20; A23K 20/24

(57) ABSTRACT

The present invention relates to a pecking block for birds and a method of producing the same. The pecking block comprises: a filler material comprising diatomaceous earth or a combination of diatomaceous earth and a clay-based material or mineral; a wetting agent; and optionally, one or more additives selected from the group consisting of (a) one or more mold inhibitors, (b) one or more binding agents, (c) one or more coloring agents, (d) one or more scenting agents; and (e) a combination thereof.

### CROSS REFERENCE TO RELATED APPLICATIONS

This application claims priority of U.S. Provisional Patent Application No. 62/728,675 and Canadian Patent Application No. 3,016,928.

### FIELD OF THE INVENTION

The present invention relates to pecking blocks for poultry and methods for their preparation. More specifically, the present invention relates to pecking blocks comprising a filler material including diatomaceous earth useful as an environment enhancer for poultry, and a method of preparing same.

### BACKGROUND OF THE INVENTION

Bird pecking or cannibalism has been a significant issue in poultry houses, which has become even more significant with the move to cage free and free range poultry and particularly in poultry houses with a large population of birds. In large scale operations, many thousands of birds can be contained in a single structure/area. In such settings, it is common for birds to become aggressive towards one another which can lead to mortality rates as high as 3-5%. In addition to high bird mortality rates, the problem also results in stress in other birds within the environment which results in decreased egg production in laying operations.

To mitigate or arrest this problem, environmental enhancers have been employed in poultry houses to distract and occupy the birds or provide an outlet for their natural pecking behavior. Such devices include concrete blocks, colorful items such as soda cans, hay bales, as well as commercial blocks containing seeds, grains and minerals.

With respect to concrete blocks, birds may initially peck at these but can readily lose interest as the pecking action does not provide results for the bird. Specifically, it is difficult for the birds to dislodged or peck off pieces the block. Soda cans suffer the same issue. Although hay bales serve to occupy the birds, they are deconstructed too quickly by the birds and thus do not have a long life in a poultry house. This is also true with respect to seed/feed blocks. Further due to the nutritive value of hay and seed, the introduction of hay bales/feed blocks in the poultry house could interfere with the nutrition program the birds are on, thus preventing the birds from reaching their full genetic potential.

FR2844152 discloses poultry feed which is in a block form. The feed block consists of cereals such as wheat, barley, oats and maize, mixed with powdered or granulated minerals such as calcium, phosphorus, magnesium or sodium, particles of oyster shells and a liquid binding agent. The mixture is poured into a bowl or pail to make a molded block once it has set. The block is intended to be consumed by the birds.

U.S. Pat. No. 3,293,039 relates to a pecking stone for small domesticated birds to allow the birds to peck while at the same time discouraging pecking of other objects in the home. The pecking composition is comprised of oyster shell, gravel, charcoal, pumice, glastone, honey, cod liver oil, table salt and water which is molded into a hard homogeneous mass.

There is a need for further pecking blocks to enhance the environment of birds in poultry houses, such as chickens, ducks, turkeys and geese.

This background information is provided for the purpose of making known information believed by the applicant to be of possible relevance to the present invention. No admission is necessarily intended, nor should be construed, that any of the preceding information constitutes prior art against the present invention.

### SUMMARY OF THE INVENTION

In accordance with one embodiment of the present invention there is provided a pecking block for birds which comprises: a filler material comprising diatomaceous earth or a combination of diatomaceous earth and a clay-based material or mineral; a wetting agent; and optionally, one or more additives selected from the group consisting of (a) one or more mold inhibitors, (b) one or more binding agents, (c) one or more coloring agents, (d) one or more scenting agents; and (e) a combination thereof.

Another embodiment of the present invention provides a method of producing a pecking block for birds. The method includes the step of obtaining a filler material comprising diatomaceous earth or a combination of diatomaceous earth and a clay-based material or mineral wherein the filler material is in granular form. The filler material is combined with a wetting agent, and optionally one or more additives selected from the group consisting of (a) one or more mold inhibitors, (b) one or more binding agents, (c) one or more coloring agents, (d) one or more scenting agents, and (e) a combination thereof, to form a mixture. The mixture is provided to a block mold; and the material is compressed in the block mold to form the pecking block. The pecking block is thereafter ejected from the block mold.

In another aspect, a pecking block for birds is provided, wherein the block consists essentially of, or consists of, diatomaceous earth, calcium bentonite and EZ GLO™.

The pecking block can enhance the birds environment providing an outlet for the natural pecking behavior of birds, reducing birds' aggressive pecking at each other and reducing stress of other birds within the environment. The pecking block is suitable for use with a wide variety of birds, such as chickens, ducks, turkeys and geese.

### BRIEF DESCRIPTION OF THE FIGURES

For a better understanding of the present invention, as well as other aspects and further features thereof, reference is made to the following description which is to be used in conjunction with the accompanying drawings, where:

FIG. 1 illustrates an example of plurality of pecking blocks according to the present application, prepared in a similar manner as set forth in Example 1, having a generally cuboid shape and placed on a pallet.

FIG. 2(a) illustrates an example of a pecking block according to the present application following placement in an environment containing chickens for a period of time.

FIG. 2(b) illustrates an example of small piece of a pecking block according to the present application that has been pecked away by chickens (chicken feather and wallet shown for scale).

FIG. 3 illustrates an example of a cylindrical pecking block according to the present application as described in Example 5.

### DETAILED DESCRIPTION

Unless defined otherwise, all technical and scientific terms used herein have the same meaning as commonly understood by one of ordinary skill in the art to which this invention belongs.

As used in the specification and claims, the singular forms “a”, “an” and “the” include plural references unless the context clearly dictates otherwise.

The term “comprising” as used herein will be understood to mean that the list following is non-exhaustive and may or may not include any other additional suitable items, for example one or more further feature(s), component(s) ingredient(s) and/or elements(s) as appropriate.

Terms of degree such as “substantially”, “about” and “approximately” as used herein mean a reasonable amount of deviation of the modified term such that the end result is not significantly changed. These terms of degree should be construed as including a deviation of at least ±5% of the modified term if this deviation would not negate the meaning of the word it modifies.

In one embodiment, a pecking block for birds is provided, wherein the pecking block comprises: a filler material comprising diatomaceous earth or a combination of diatomaceous earth and a clay-based material or mineral; a wetting agent; and optionally, one or more additives selected from the group consisting of (a) one or more mold inhibitors, (b) one or more binding agents, (c) one or more coloring agents, (d) one or more scenting agents; and (e) a combination thereof. The block can be used in facilities housing poultry, both in large scale poultry houses and small scale facilities such as backyard coops. In one embodiment, the filler material is present in an amount of from about 70-98% by weight, the additive is present in an amount of from about 0 to 28% by weight, and the wetting agent is present in an amount of from about 2-15% by weight.

The filler materials used in the blocks of the present application can be obtained commercially. One example of a commercially available filler material is diatomaceous earth granular (Barn Fresh™) by Absorbent Products Ltd. The filler materials can also be obtained from naturally occurring sources. Naturally occurring deposits including diatomaceous earth are known and include deposits of substantially pure diatomaceous earth, such as for example the Oregon diatomaceous earth deposits in Westfall; deposits which comprise both diatomaceous earth and calcium bentonite, such as that found for example in the Absorbent Products Ltd. mine known as Red Lake Deposit in Kamloops, B. C.; and deposits which comprise zeolite, such as found for example the Princeton B. C. mine.

A wetting agent is utilized to aid in compressing the block and to aid in adhesion of the granular materials when forming the block. A suitable wetting agent is water (which can be added in liquid form to prepare the block, and/or water vapor/steam can be used in block preparation) although other known wetting agents can be utilized. Preferably the wetting agent is in an amount of about 2 to about 15% by weight, more preferably in an amount of 3 to about 10% by weight, or about 4-6% by weight, based on the total weight of the composition of the block.

In another embodiment, the clay-based material or mineral is selected from the group consisting of smectite, attapulgite, sepiolite, bentonite, kaolinite, gypsum, zeolite, montmorillonite, calcium carbonate and a combination thereof.

The clay-based material or minerals, in addition to forming part of the filler material, can also act as density variating agents to vary the density of the block to encourage uneven wear of the block, flaking and chipping by the birds. As an example, in one embodiment, zeolite crystals and/or calcium carbonate are added to the block composition.

Colouring agents can act as a further attractant to the birds. Examples of suitable colouring agents, include food coloring, such as Bakers FD and C green food colour, red food colour (such as for example red dye #40), blue food colour, and yellow food colour (such as for example yellow dye #4). In one embodiment, such coloring agents are present in nominal amounts (i.e. less than 1% by weight of the total composition).

Binders (i.e. binding agents) can be added to aid in block formation. Suitable binders are known to those of skill in the art. In one embodiment, the one or more binding agents is selected from the group consisting of bentonite, guar gum, molasses or molasses-based products such as EZ GLO™ (e.g. EZ GLO™ 5-68 EZ Guard or other EZ GLO™ products), lignosulfonate, and a combination thereof. In one embodiment, the binding agent can be present in an amount of up to about 28% by weight.

Mold inhibitors can also be added to the block composition. Examples of suitable mold inhibitors include citric acid, calcium propionate (Ca(C₃H₅O₂)₂), and commercially available mold inhibitors such as Mold-Zap™, Mold-X™, and MOLD-NIL™. The amount of mold inhibitor added to the block composition may vary between about 0.2% and 2% by weight of the total composition. The amount of mold inhibitor utilized in the block is dependent on severity of mold issue, climate conditions, humidity levels and time of year. As an alternative to or in addition to the use of mold inhibitors in the block composition, mold inhibiting processes can also be carried out, such as drying.

While birds do not have olfactory abilities, a scenting agent may be added to the block composition for marketing purposes to appeal to the purchaser. Suitable scenting agents include malabate, fresh linen scent, lemon grass, Scent leaf (ocimum gratissimum) and other commercially available scenting agents. In one embodiment, such scenting agents are present in nominal amounts (i.e. less than 1% by weight of the total composition).

In still another embodiment, the filler material is diatomaceous earth and the wetting agent is water. In yet another embodiment, the pecking block consists essentially of, or consists of, diatomaceous earth, a binding agent, and water.

In still yet another embodiment, the pecking block consists essentially of, or consists of, diatomaceous earth and water. In another embodiment, the diatomaceous earth is present in an amount of from about 85-98% by weight and the water is present in an amount of from about 2-15% by weight.

In yet another embodiment, the clay-based material or mineral is selected from calcium bentonite, or zeolite.

In another embodiment, the filler material is a combination of diatomaceous earth and calcium bentonite, and the wetting agent is water. In yet another embodiment, the pecking block consists essentially of, or consists of, diatomaceous earth, calcium bentonite, and water. In still yet another embodiment, the combination of diatomaceous earth and calcium bentonite is present in an amount of from about 85-98% by weight and the water is present in an amount of from about 2-15% by weight. In another embodiment, the water is present in an amount of about 4-6% by weight.

In another embodiment, the filler material is a combination of diatomaceous earth and zeolite, and the wetting agent is water. In yet another embodiment, the pecking block consists essentially of, or consists of, diatomaceous earth, zeolite, and water. In still yet another embodiment, the combination of diatomaceous earth and zeolite is present in an amount of from about 85-98% by weight and the water is present in an amount of from about 2-15% by weight.

In another embodiment, the block has a generally cuboid shape. In still yet another embodiment, the block has a weight of from about 2 pounds to about 50 pounds. In other embodiments the produced blocks have weights of about 25 or about 33 lbs.

In one embodiment, the filler material is a combination of diatomaceous earth and calcium bentonite, the wetting agent is water, and the block further comprises molasses or a molasses-based product as a binding agent. In another embodiment, the pecking block consists essentially of, or consists of, diatomaceous earth, calcium bentonite, water, and molasses or a molasses-based product. In yet another embodiment, the molasses-based product is EZ GLO™.

In one embodiment, the pecking block consists essentially of, or consists of, diatomaceous earth, calcium bentonite, water, and EZ GLO™. In one embodiment, the EZ GLO™ is present in an amount of from about 15% to about 25% by weight. In another embodiment, the EZ GLO™ is present in an amount of about 20% by weight.

In yet another embodiment, a method of producing a pecking block for birds is provided, the method comprising: obtaining a filler material comprising diatomaceous earth or a combination of diatomaceous earth and a clay-based material or mineral, wherein the filler material is in granular form; combining the filler material with a wetting agent, and optionally one or more additives selected from the group consisting of (a) one or more mold inhibitors, (b) one or more binding agents, (c) one or more coloring agents, (d) one or more scenting agents, and (e) a combination thereof, to form a mixture; providing the mixture to a block mold; compressing the mixture in the block mold to form said pecking block; and ejecting the pecking block from the block mold.

The wetting agent (e.g. water) can be combined with the filler material and any additives that may be present in an amount of from about 2% to about 15%, or from about 3% to about 10% by weight of the total mixture. As those of skill in the art will appreciate, the percentage of water can be adjusted according to the moisture levels and particle size distribution of the filler material. As those of skill in the art will appreciate, the compressing step can remove a portion of the wetting agent during block formation. Final percentages of wetting agent (e.g. water) in the final block product can range from about 2 to about 15% by weight.

The clay-based material or mineral can be as described above. In another embodiment, the one or more mold inhibitors, one or more binding agents, one or more coloring agents, and one or more scenting agents are as defined above.

The filler material can be as described above. In another embodiment, the filler material has a size of between about 10 to about 400 mesh based on US Standard Mesh Scale. Smaller particles sizes in the filler material aids in consistent blending of the block composition while including larger particle sizes within the filler materials aids in formation of the block when compressed. Thus a filler material with both smaller and larger particle sizes is particularly desirable.

The step of combining can be carried out in a mixing chamber/bin capable of metering out the proper amount of the mixture into the block mold. Once the mixture has been provided to the block mold, a hydraulic cylinder with a pressure plate can be used to prepare the block. The hydraulic cylinder with the pressure plate is lowered and pressure is applied to the mixture while in the mold to form compressed blocks. The amount of pressure can vary depending on the size and desired hardness of the block and the materials in the block composition being compressed. Generally, the pressure can range from about 800 to about 2600 psi. Once the block is formed it is removed from the block mold and can be deposited onto a conveyor. In yet another embodiment, the method further comprises a step of applying heat to the block to remove moisture from an outer surface of the block. As an alternative to applying heat or in addition to apply heat, directed air flow can be used to effect the removal of moisture from the outer surface of the block. However, kiln drying is not necessary, as a certain amount of moisture remaining in the block is acceptable.

In another embodiment, the method further comprises cooling the block. Thereafter, the block can be packaged as desired.

In one embodiment of the above-noted method, the wetting agent is water. In another embodiment, the method further comprises adding steam prior to or during the compressing step to aid in compression and binding of the materials into the block form.

In one embodiment, in the molding process, the step of applying a pressure includes applying a first lower pressure in the range of from about 800 to about 1600 psi, for a period of time from about 1 to about 30 seconds and thereafter applying a second higher pressure of from about 1200 to about 2600 psi for a time period of from about 1 to about 30 seconds. In another embodiment a first lower pressure of about 800 psi is applied for a period of about 1-30 seconds and a second higher pressure of about 1200 psi is applied for about 1-30 seconds. In another embodiment, a single pressure of from about 800 psi to about 2600 psi is applied for a time period of from about 1 to about 30 seconds, such as for about 5 seconds. In another embodiment, a pressure of about 1000 psi is applied for about 5 seconds. Those of skill in the art will appreciate that different pressures can be applied in order to create different levels of hardness of the blocks. For instance, harder blocks may be more desirable for larger birds, and softer blocks may be more desirable for smaller birds.

The blocks can be of any desired size or shape. In one embodiment, the block has a generally cuboid shape. In yet another embodiment, the block has a weight of from about 20 pounds to about 50 pounds. Generally, the size of the blocks is dependent on the number and size of the birds. Larger blocks, such as blocks of approximately 20-50 lbs are preferred for large scale poultry houses where hundreds or thousands of birds can be housed. A particularly preferred block size for a large scale poultry house is about 33 lbs, although other block sizes can be used (e.g. 25 lbs). Smaller blocks, such as blocks of about 2-10 lbs are more desirable for smaller scale uses/smaller birds such as for use in “backyard” chickens.

Additionally, the hardness of the block can be varied depending on both the size and age of birds as well as the type of birds. Softer blocks may be desired for chicks and pullets or smaller birds whereas harder blocks are preferred for larger and more aggressive birds such as turkeys.

The pecking blocks can be placed on the floor of the poultry house itself or alternately, the blocks can be hung or suspended above the ground. Hanging the blocks at the birds eye level may be more enticing for the birds.

On pecking of the blocks, small pieces of the blocks may break off or dislodge, thereby holding the interest of the birds for extended periods.

The blocks prepared in accordance with the present application are particularly advantageous, as they do not contain nutritive ingredients or contain only negligible amounts of nutritive ingredients as consumed by the birds. For instance, the blocks of the present application do not contain nutritive ingredients such as feed, seeds, insects, nutritional supplements which may affect metabolism, etc.—thus, it is expected that the blocks of the present application will not interfere with the nutrition program the birds are on, which can allow the birds to reach their full genetic potential. It is further noted that the diatomaceous earth which is present in the pecking blocks described herein has insecticidal properties.

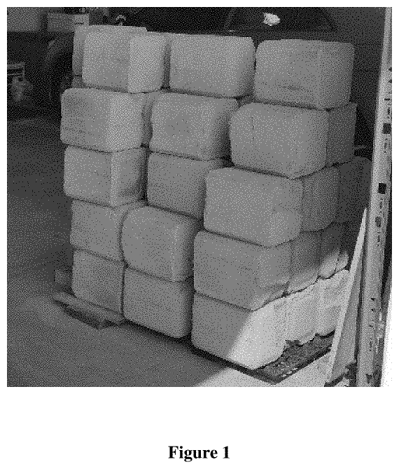

The blocks described herein can be constructed economically and reproducibly, having a consistent moisture content and hardness level. Further, the blocks can be easily packaged and shipped, due to their uniform format (e.g. when they are formed in a cuboid shape) which allows them to be stacked and palletized. FIG. 1 illustrates an example of a plurality of pecking blocks according to the present application, prepared in a similar manner as set forth in Example 1. As can be seen from FIG. 1, the example blocks have a generally cuboid shape and have been placed on a pallet.

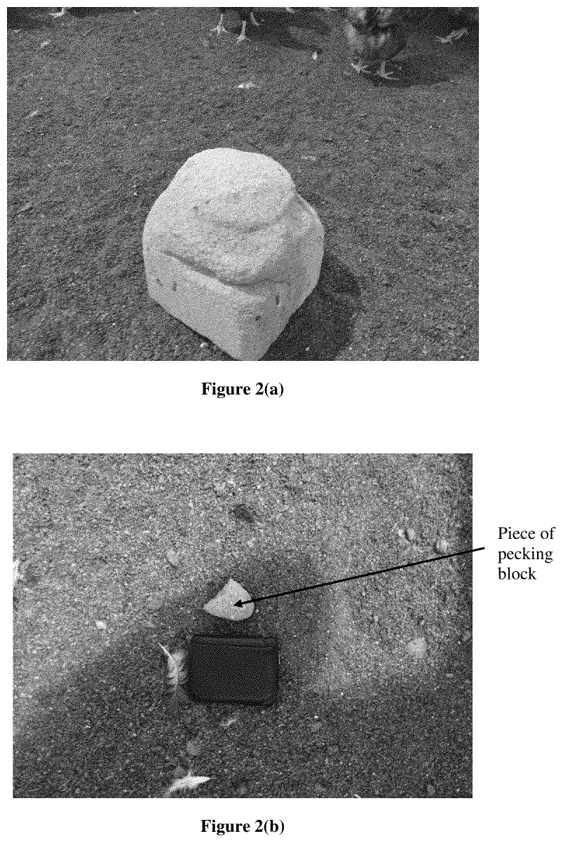

FIG. 2(a) illustrates an example of a pecking block according to the present application following placement in an environment containing chickens for a period of time. As can be seen from FIG. 2(a), a portion of the block has been pecked away by the chickens. FIG. 2(b) illustrates an example of a small piece of a pecking block according to the present application that has been pecked away by chickens (chicken feather and wallet shown for scale).

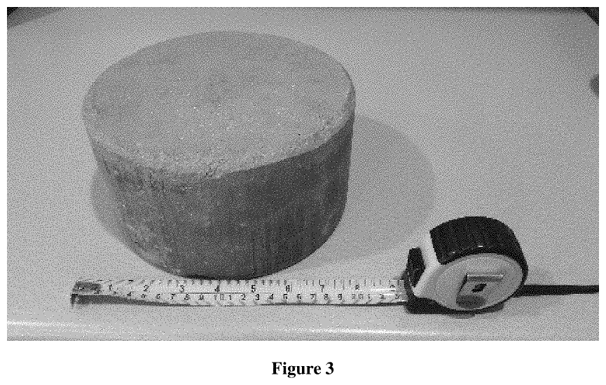

FIG. 3 illustrates an example of a cylindrical pecking block according to the present application as described in Example 5.

### Example 1

A pecking block comprised of a blend of diatomaceous earth and calcium bentonite was constructed. The blend of diatomaceous earth and calcium bentonite was dried, crushed and screened to a granular particle size of about 40 to 300 mesh.

The granular blend of diatomaceous earth and calcium bentonite was mixed with about 10% by weight of water as a wetting agent (wherein the % by weight of water is based on the total weight of the mixture of diatomaceous earth, calcium bentonite, and water) in a continuous mixer to aid in the activation of the natural binding properties of calcium bentonite and aid in compression. The mixture was then metered out in the amount of about 33 lbs. and transferred to a block mold of a Landers Block Press with a 100 ton compression ram. Once in the mold pressure of about 1000 psi was applied to the mixture in the mold for about 5 seconds to form the block. The formed block was transferred from the mold to a conveyor where heat was applied for about 20-30 seconds to dry off the moisture on the outside of the block.

The final composition of the pecking block was estimated to have a combined amount of diatomaceous earth and calcium bentonite of about 95% by weight and residual water in an amount of about 5% by weight.

### Example 2

A single 33 lbs pecking block manufactured according to Example 1 was provided to a poultry house housing 6,700 turkeys. The turkeys had an average weight of 5 lbs each. The block was pecked down to almost nothing in 12 days.

Thus, 6,700 birds pecked away a 33 lbs block in 12 days, which equals approximately 0.0049 lbs per bird. Divided by 12 days equals about 0.00041 lbs per bird per day, which is equivalent to 0.00656 oz/bird/day or about 0.186 grams/bird/day.

### Example 3

Four 33 lbs pecking blocks manufactured according to Example 1 were provided to a large commercial layer house containing 18,000 birds. The birds were breeder/layers having an average size of about 2.8-3.3 lbs per bird. After 9 days, about ⅔ of each of the blocks were gone, with only ⅓ of each of the blocks remaining. Approximately 20 lbs of each block was pecked away in 9 days.

About 20 lbs per block×4 blocks=approximately 80 lbs of the blocks were pecked away by 18,000 birds in 9 days. This equates to about 0.0044 lbs per bird over 9 days which is equivalent to 0.00049 lbs/bird/day, 0.0079 oz/bird/day or about 0.224 grams/bird/day.

### Example 4

A pecking block comprised of a blend of diatomaceous earth and calcium bentonite and EZ GLO™ 5-68 EZ Guard by Westway Feed Products was constructed. EZ GLO™ is a molasses based product comprising about 31.5% moisture (i.e. water).

The blend of diatomaceous earth and calcium bentonite was dried, crushed and screened to a granular particle size of about 40 to 300 mesh.

The granular blend of diatomaceous earth and calcium bentonite was mixed with about 20% by weight of the EZ GLO™ in a continuous mixer. Steam was applied to the mixture to bring the mixture to a temperature of 100° C. The mixed composition was then metered in the amount of about 25 lbs. and then the mixture was transferred to a block mold of a Landers Block Press with a 100 ton compression ram. Once in the mold a first pressure of about 800 psi was applied for about 6 seconds and a second pressure of about 1200 psi for about 6 seconds was applied to form the block. The formed block was removed from the mold.

The final composition of the pecking block was estimated to have a combined amount of diatomaceous earth and calcium bentonite of about 80% by weight and EZ GLO™ in an amount of about 20% by weight.

### Example 5

A pecking block comprised of a blend of diatomaceous earth and calcium bentonite was constructed. The blend of diatomaceous earth and calcium bentonite was dried, crushed and screened to a granular particle size of about 40 to 300 mesh.

About 22 lbs. (10 kg) of the granular blend of diatomaceous earth and calcium bentonite was mixed in a cement mixer. Using a spray bottle, 1 litre of water was added to the granular blend of diatomaceous earth and calcium bentonite under continued mixing conditions. The mixture was allowed to mix for about 3 minutes following addition of all of the water, then a cylindrical block mold was filled with the mixture. It was estimated that the block mold initially held about 6.6 lbs. (3 kg).

The piston was inserted and pressure was applied to the die face (8″ diameter) from a 20-ton hydraulic jack (compression ram) until the die compressed about 1 inch (about 2.54 cm). The piston was removed and the mold was topped up with the above-noted mixture. Pressure was then re-applied, and the hydraulic pump was re-pressurized periodically as the mixture compressed. The unit was left pressurized overnight.

The bottom of the die was removed, the block was pressed out, and the compressed block was allowed to air dry.

The final composition of the pecking block was estimated to have a combined amount of diatomaceous earth and calcium bentonite of about 95% by weight and residual water in an amount of about 5% by weight. The final weight of the block was about 9 lbs. (about 4 kg).

### Example 6

A pecking block comprised of a blend of diatomaceous earth and calcium bentonite, together with sodium bentonite and citric acid was constructed. The blend of diatomaceous earth and calcium bentonite and the sodium bentonite were dried, crushed and screened to a granular particle size of about 40 to 300 mesh.

About 15.4 lbs. (7 kg) of the blend of diatomaceous earth and calcium bentonite was combined with about 3.9 lbs. (1.75 kg) of sodium bentonite in a cement mixer and mixed for about 5 minutes. Citric acid in an amount of about 0.6 lbs. (0.25 kg) was dissolved in 1 litre of hot water, and this solution was added to the granular blend of diatomaceous earth, calcium bentonite, and sodium bentonite under continued mixing conditions using a spray bottle. The mixture was allowed to mix for about 10 minutes following addition of all of the solution, then a cylindrical block mold was filled with the mixture. It was estimated that the block mold initially held about 6.6 lbs. (3 kg).

The piston was inserted and pressure was applied from a 25-ton hydraulic shop press (compression ram) to the die face until the die compressed about 1 inch (about 2.54 cm). The 25-ton hydraulic shop press was run at a pressure of about 8,000-9,500 psi, translating to a pressure of up to about 189 psi on the 8″ diameter die face. The piston was removed and the mold was topped up with the above-noted mixture. Pressure was then re-applied for different lengths of time as follows:

Block #1—pressure applied until the 25-ton hydraulic shop press reached a pressure of about 9,500 psi (estimated to take between 3-4 minutes), and the block was left under pressure overnight.

Block #2—pressure applied until the 25-ton hydraulic shop press reached a pressure of about 9,500 psi (estimated to take between 3-4 minutes), and this pressure was held for 1 minute.

Block #3—pressure applied until the 25-ton hydraulic shop press reached a pressure of about 9,500 psi (estimated to take between 3-4 minutes), and this pressure was then immediately removed.

For each of the above-noted blocks, the bottom of the die was removed, the block was pressed out, and the compressed block was allowed to air dry. Block #1 was quite hard. Block #2 was not as hard as Block #1, but compressed well and had superior stability relative to Block #3.

The final composition of the pecking blocks was estimated to have a combined amount of diatomaceous earth, calcium bentonite, sodium bentonite, and citric acid of about 90-95% by weight and residual water in an amount of about 5-10% by weight. The final weight of each of the blocks was about 9-10 lbs. (about 4-4.5 kg).

All publications, patents and patent applications mentioned in this Specification are indicative of the level of skill of those skilled in the art to which this invention pertains and are herein incorporated by reference to the same extent as if each individual publication, patent, or patent application was specifically and individually indicated to be incorporated by reference.

Although the present invention has been described with reference to the preferred embodiments, it is to be understood that modifications and variations may be resorted to without departing from the spirit and scope of the invention, as those skilled in the art readily understand. Such modifications and variations are considered to be within the purview and scope of the invention and the appended claims.

1. A pecking block for birds comprising:
a filler material comprising diatomaceous earth or a combination of diatomaceous earth and a clay-based material or mineral;
a wetting agent; and
optionally, one or more additives selected from the group consisting of (a) one or more mold inhibitors, (b) one or more binding agents, (c) one or more coloring agents, (d) one or more scenting agents; and (e) a combination thereof.

2. The pecking block according to claim 1, wherein the filler material is present in an amount of from about 70-98% by weight, the one or more additives are present in an amount of from about 0 to 28% by weight, and the wetting agent is present in an amount of from about 2-15% by weight.

3. The pecking block according to claim 1 wherein the wetting agent is water.

4. The pecking block according to claim 1, further comprising one or more of the following characteristics:
(a) the clay-based material or mineral is selected from the group consisting of smectite, attapulgite, sepiolite, bentonite, kaolinite, gypsum, zeolite, montmorillonite, calcium carbonate and a combination thereof;
(b) the one or more mold inhibitors is selected from the group consisting of citric acid, calcium propionate, Mold-Zap™, Mold-X™, MOLD-NIL™, and a combination thereof;
(c) the one or more binding agents are selected from the group consisting of bentonite, guar gum, molasses or molasses-based products (such as EZ GLO™), lignosulfonate, and a combination thereof;
(d) the one or more coloring agents are selected from the group consisting of Bakers FD and C green food colour, yellow dye #4, and red dye #40;
(e) the block has a generally cuboid shape; and
(f) the block has a weight of from about 20 pounds to about 50 pounds.

5.-8. (canceled)

9. The pecking block according to claim 1, wherein:
(a) the filler material is diatomaceous earth and the wetting agent is water;
(b) the clay-based material or mineral is selected from calcium bentonite, or zeolite;
(c) the filler material is a combination of diatomaceous earth and calcium bentonite, and the wetting agent is water; or
(d) the filler material is a combination of diatomaceous earth and zeolite, and the wetting agent is water.

10. The pecking block according to claim 1, wherein the pecking block consists essentially of, or consists of, diatomaceous earth, a binding agent, and water.

11. The pecking block according to claim 1, wherein the pecking block consists essentially of, or consists of, diatomaceous earth and water; optionally, wherein the diatomaceous earth is present in an amount of from about 85-98% by weight and the water is present in an amount of from about 2-15% by weight.

12.-14. (canceled)

15. The pecking block according to claim 1, wherein the pecking block consists essentially of, or consists of, diatomaceous earth, calcium bentonite, and water; optionally, wherein the combination of diatomaceous earth and calcium bentonite is present in an amount of from about 85-98% by weight and the water is present in an amount of from about 2-15% by weight.

16.-17. (canceled)

18. The pecking block according to claim 1, wherein the pecking block consists essentially of, or consists of, diatomaceous earth, zeolite, and water; optionally, wherein the combination of diatomaceous earth and zeolite is present in an amount of from about 85-98% by weight and the water is present in an amount of from about 2-15% by weight.

19.-21. (canceled)

22. A method of producing a pecking block for birds comprising:
obtaining a filler material comprising diatomaceous earth or a combination of diatomaceous earth and a clay-based material or mineral wherein the filler material is in granular form;
combining the filler material with a wetting agent, and optionally one or more additives selected from the group consisting of (a) one or more mold inhibitors, (b) one or more binding agents, (c) one or more coloring agents, (d) one or more scenting agents, and (e) a combination thereof, to form a mixture;
providing the mixture to a block mold;
compressing the mixture in the block mold to form said pecking block; and
ejecting the pecking block from the block mold.

23. The method of claim 22, wherein the wetting agent is water.

24. The method according to claim 22, further comprising one or more of the following characteristics:
(a) the method further comprises adding steam prior to or during the compressing step;
(b) said compressing step comprises applying pressure to said mixture for about 1 to 30 seconds to form said block;
(c) said compressing step comprises applying a first pressure of about 800 to about 1,600 psi for about 1 to about 30 seconds to said mixture and subsequently applying a second pressure of about 1,200 to about 2,600 psi for about 1 to about 30 seconds to said mixture;
(d) said compressing step comprises applying pressure to said mixture up to about 2,600 psi, or up to about 1,000 psi, for about 1 to 30 seconds to form said block;
(e) the method further comprises a step of applying heat to the block to remove moisture from an outer surface of the block; and
(f) the method further comprises cooling the block.

25.-29. (canceled)

30. The method according to claim 22, further comprising one or more of the following characteristics:
(a) the clay-based material or mineral is selected from the group consisting of smectite, attapulgite, sepiolite, bentonite, kaolinite, gypsum, zeolite, montmorillonite, calcium carbonate and a combination thereof;
(b) the one or more mold inhibitors is selected from the group consisting of citric acid, calcium propionate, Mold-Zap™, Mold-X™, MOLD-NIL™, and a combination thereof;
(c) the one or more binding agents are selected from the group consisting of bentonite, guar gum, molasses or molasses-based products (such as EZ GLO™), lignosulfonate, and a combination thereof;
(d) the one or more coloring agents are selected from the group consisting of Bakers FD and C green food colour, yellow dye #4, and red dye #40;
(e) the block has a generally cuboid shape; and
(f) the block has a weight of from about 20 pounds to about 50 pounds.

31.-34. (canceled)

35. The method according to claim 22, wherein:
(a) the filler material is diatomaceous earth and the wetting agent is water;
(b) the clay-based material or mineral is selected from calcium bentonite, or zeolite;
(c) the filler material is a combination of diatomaceous earth and calcium bentonite, and the wetting agent is water; or
(d) the filler material is a combination of diatomaceous earth and zeolite, and the wetting agent is water.

36. The method according to claim 22, wherein the pecking block consists essentially of, or consists of, diatomaceous earth, a binding agent, and water.

37. The method according to claim 22, wherein the pecking block consists essentially of, or consists of, diatomaceous earth and water.

38.-39. (canceled)

40. The method according to claim 22, wherein the pecking block consists essentially of, or consists of, diatomaceous earth, calcium bentonite, and water.

41. (canceled)

42. The method according to claim 22, wherein the pecking block consists essentially of, or consists of, diatomaceous earth, zeolite, and water.

43.-44. (canceled)

45. The method according to claim 22, wherein the filler material has a size of between about 10 to about 400 mesh.

46.-53. (canceled)
